(19) United States
(12) Patent Application Publication
(10) Pub. No.: US 2007/0277689 A1
(43) Pub. Date: Dec. 6, 2007

(54) Highly versatile multiconfiguration printing assembly

(75) Inventor: Federico D'Annunzio, Cislago (IT)

Correspondence Address: MODIANO & ASSOCIATI, VIA MERAVIGLI, 16, MILAN, 20123, omitted

(73) Assignee: GIDUE S.p.A.

(21) Appl. No.: 11/806,105

(22) Filed: May 30, 2007

(30) Foreign Application Priority Data
Jun. 6, 2006 (IT) MI2006A001102

(51) Int. Cl. B41K 1/38

(52) U.S. Cl. 101/335

(57) ABSTRACT

A multiconfiguration printing assembly comprising a first inking assembly for a first type of printing, a second inking assembly for a second type of printing, a printing roller related to the first type of printing and a printing roller related to the second type of printing, a single contrast roller being provided and being common to the printing rollers.

The present invention relates to a highly versatile multiconfiguration printing assembly. More particularly, the invention relates to a printing assembly which can perform two different types of printing simultaneously without having to modify the printing assembly.

### BACKGROUND OF THE INVENTION

As is known, one of the main difficulties in the field of printing is the ability to change rapidly the type of printing, changing for example from rotogravure printing to flexographic printing or to offset printing or to hot printing or screen printing.

In such cases, the operator is forced to change the printing rollers or cylinders, with considerable downtimes for the printing operation, and it is necessary to have specialized personnel replacing the rollers in order to change the type of printing.

Also, if it is necessary to perform two kinds of printing on the same medium to produce different printouts and the two different types of printing are for example flexographic and offset, it is necessary to perform two passes inside the printing machine, either on the same machine, after replacing the printing assemblies, or on a different machine which performs the selected different type of printing.

This of course entails drawbacks.

Moreover, each printing assembly is provided with its own drying device, and therefore two different printing assemblies normally require two separate drying devices. This leads to doubled costs and to unwanted space occupation as regards the printing machine.

### SUMMARY OF THE INVENTION

The aim of the present invention is to provide a multiconfiguration printing assembly which can perform simultaneously two different types of printing without requiring appropriately provided contrast rollers and separate drying devices.

Within this aim, an object of the present invention is to provide a multiconfiguration printing assembly in which the space occupation of the printing assembly is as small as possible.

Another object of the present invention is to provide a multiconfiguration printing assembly which allows to have two different types of printing simultaneously on the same medium.

Still another object of the present invention is to provide a multiconfiguration printing assembly which is highly reliable, relatively simple to provide and at competitive costs.

This aim and these and other objects, which will become better apparent hereinafter, are achieved by a multiconfiguration printing assembly, characterized in that it comprises a first inking assembly for a first type of printing, a second inking assembly for a second type of printing, a printing roller related to said first type of printing and a printing roller related to said second type of printing, a single contrast roller being provided and being common to said printing rollers.

### BRIEF DESCRIPTION OF THE DRAWING

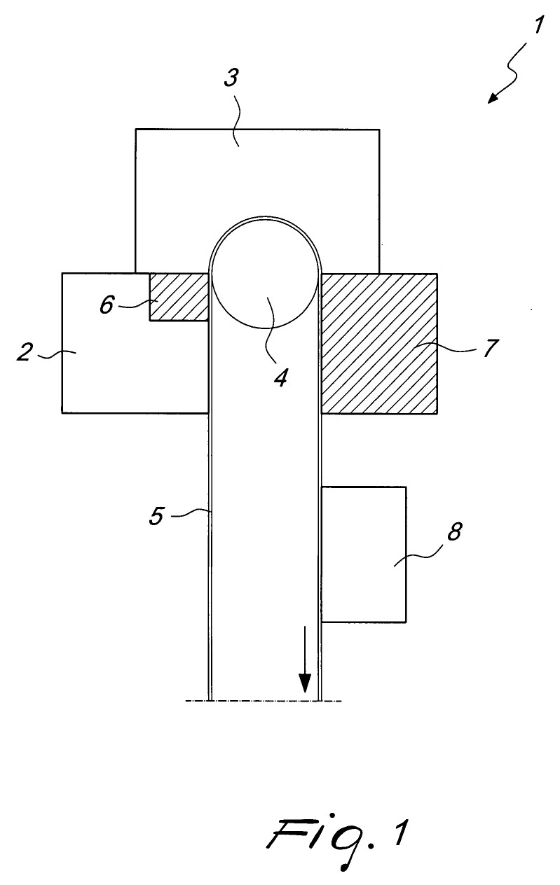

Further characteristics and advantages of the invention will become better apparent from the description of a preferred but not exclusive embodiment of the multiconfiguration printing assembly according to the present invention, illustrated by way of nonlimiting example in the accompanying drawing of FIG. 1, wherein the only figure is a schematic view of the multiconfiguration printing assembly according to the present invention.

### DESCRIPTION OF THE PREFERRED EMBODIMENTS

With reference to FIG. 1, the multiconfiguration printing assembly according to the present invention, generally designated by the reference numeral 1, comprises a first inking assembly 2 and a second inking assembly 3, which are arranged substantially adjacent to each other, and the first and second inking assemblies can comprise an inking assembly of the flexographic, rotogravure, offset type and the like.

The first and second inking assemblies 2 and 3 share a common contrast roller 4, around which a medium 5, onto which printing is to be performed, passes.

The first inking assembly 2 is provided with a corresponding first printing roller 6, which transfers the ink that is present in the inking assembly 2 onto the print medium 5. Likewise, the second inking assembly 3 is provided with its own second printing roller 7, which also transfers the ink that is present in the inking assembly 3 onto the medium 5, abutting against the common contrast roller 4.

Downstream of the first and second inking assemblies a drying device 8 is provided, which is common to both inking assemblies and is therefore common to both types of printing that can be performed on the multiconfiguration printing assembly according to the present invention.

Substantially, therefore, the multiconfiguration printing assembly according to the invention provides for the implementation of two distinct printing methods on the same contrast roller 4 simultaneously and with the presence of a single drying device 8 which is arranged downstream of the two adjacent printing assemblies.

As can be seen, therefore, the additional advantage of the multiconfiguration printing assembly according to the present invention is that one contrast roller has been eliminated, since the contrast roller 4 has been made common to both inking assemblies 2 and 3, and one drying device has also been eliminated by making the drying device 8 common to both inking assemblies and therefore to both types of printing. Most of all, however, the multiconfiguration printing assembly according to the present invention has the considerable advantage of allowing two printing methods on the same contrast roller simultaneously, a feature which is not possible in printing assemblies of the background art.

In practice it has been found that the multiconfiguration printing assembly according to the present invention fully achieves the intended aim and objects, since it allows to provide printing according to two distinct types simultaneously on a same contrast roller and with a single drying device for both types of printing performed simultaneously.

Moreover, as can be seen, the multiconfiguration printing assembly avoids the need to change the printing assembly when one wishes to perform printing of a different type, consequently eliminating downtimes and associated costs.

The printing assembly thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application no. MI2006A001102, from which this application claims priority, are incorporated herein by reference.

What is claimed is:

1. A multiconfiguration printing assembly, comprising: a first inking assembly for a first type of printing; a second inking assembly for a second type of printing; a first printing roller related to said first type of printing; a second printing roller related to said second type of printing; and a single contrast roller that is provided common to said first and second printing rollers.

2. The printing assembly according to claim 1, comprising a single drying device for said first type of printing and for said second type of printing.

3. The printing assembly according to claim 1, wherein said first and second types of printing are selected among flexographic printing, rotogravure printing, offset printing, hot printing and screen printing.

4. The printing assembly according to claim 1, comprising a print medium supported by said contrast roller, and onto which printing is to be performed by said first printing roller related to said first type of printing and by said second printing roller related to said second type of printing.

5. The printing assembly according to claim 2, wherein said single drying device is arranged downstream of said first and second printing rollers.
